(19) United States
(12) Patent Application Publication
(10) Pub. No.: US 2002/0062598 A1
(43) Pub. Date: May 30, 2002

(54) Rolling Seal

(76) Inventor: Richard E. Miller, Atlantic Beach, FL (US)

Correspondence Address: Arthur G. Yeager, P.A., Suite 1305, 112 West Adams Street, Jacksonville, FL, 32202-3853, US

(21) Appl. No.: 10/050,086

(22) Filed: Jan. 14, 2002

Related U.S. Application Data
(63) Continuation-in-part of application No. 09/634,050, filed on Aug. 8, 2000, now abandoned.
(60) Provisional application No. 60/028,742, filed on Oct. 22, 1996.

(51) Int. Cl. E06B 7/16

(52) U.S. Cl. 49/475.1

(57) ABSTRACT

A seal having a wall or element contoured and of a predetermined shape as, for example, in the form of a right circular cylinder, an extension member and a curved sheet member joined to an extension member, with the curved sheet member along the element and curved about the element such that the curved sheet member is spaced from a surface to which the extension member is attached, such as a window sill, so that the curved sheet member is spaced from the surface and the element rolls and is compressed to seal the interface between the sash and the sill when the sash is closed against the sill with minimum abrasion of the seal.

### CROSS REFERENCE TO RELATED APPLICATIONS

This application is a continuation-in-part of U.S. Patent Application Ser. No. 09/634,050, filed Aug. 8, 2000, which claims the benefit of U.S. Patent Application Ser. No. 08/910,612, filed Aug. 13, 1997, (now abandoned), which claimed the benefit of U.S. Provisional Application Ser. No. 60/028,742, filed Oct. 22, 1996.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The invention relates to a seal to inhibit fluid leakage between two relatively movable surfaces with the seal being attached to one of those surfaces.

The invention is a seal which is attached to a first surface to seal the space between the first surface and a second surface when there is relative motion of the surfaces, such as with one surface being stationary and the other movable, the contact between the second surface and the seal causing the seal to roll and compress. Because the seal rolls between the two surfaces, there is minimum abrasion of the seal as the seal is being compressed by rolling.

There are many needs for devices, which seal the interface between a first surface and a second surface. A common example is weather stripping, which is used to keep inside air and outside air from flowing through the interfaces at windows or doors. Several problems must be overcome in devising these seals. The surfaces have irregularities at the interfaces, so the seal must be compressible to fit tightly all along the interface, but the seal must not unduly impede relative motion of the surfaces and there must be minimum abrasion of the seal caused by the relative motion of the two surfaces in order to maximize the useful life of the seal.

2. Description of the Related Art

The compression problem is addressed in prior art, which shows various forms of seals, which are compressed between two surfaces. In U.S. Pat. No. 445,544, Cosper shows a seal that is the lateral surface of a right circular cylinder, which is compressed to an oval cross-section between two surfaces. It does not roll to minimize abrasion as it is compressed. Similar tubular seals with various cross-sections are shown in U.S. Pat. No. 2,451,450 to Spraragen, in U.S. Pat. No. 2,732,596 and German Patent No. 900,006 both to Kellner, in U.S. Pat. No. 3,518,793 to Hirtle, and in U.S. Pat. No. 4,658,548 to Gerritsen. These seals do not roll during compression in order to minimize abrasion of the seal by relative motion between the surfaces.

Thus there is a need for a seal that is compressed between two surfaces by rolling so that the rolling minimizes abrasion of the seal by the moving structure.

### BRIEF SUMMARY OF THE INVENTION

Objects of this invention include providing a seal which can be affixed to a first surface and which will be compressed to seal the interface with a second surface. A further object is to provide a seal structure which allows the seal wall or element to roll when there is relative motion of the first surface with respect to the second surface in order to minimize abrasion of the seal by the motion, which is accomplished by providing a coiled arcuate sheet member attached to the seal element. A further object is to control the resistance to roll by varying the material of composition, its thickness or its configuration. Other objects will be comprehended in the drawings and detailed description, which will make additional objects obvious hereafter to persons skilled in the art.

The invention is in general a longitudinally extending seal having a resiliently compressible wall or element contoured into a predetermined shape, for example, a generally right circular cylinder tubular or solid in cross-section, the element having an arcuate or coiled sheet member having an edge attached longitudinally along the element, with the coiled sheet member being coiled along an arc of the element and joined by another edge to an extension member which is affixed to a first surface, the coiled sheet member allowing the element to roll as it is compressed against a second surface spaced from the first surface in either of two opposing directions. In the passive state, with no pressure applied against the element in either direction, the coiled sheet member remains spaced from the first surface. With pressure applied against the element causing the element to roll in a first direction away from the coiled sheet member, the coiled sheet member adapts to a more planar configuration. When pressure is applied against the element in a second opposite direction causing the element to roll in the second direction toward the coiled sheet member, the coiled sheet member adapts to a more tightly coiled configuration. The degree of resistance or ease of roll is governed by the choice of materials and the thickness of the coiled sheet member, such that a thinner or more pliant material will roll more easily than a thicker or less pliant material, as well as by the configuration of the surface of the extension member adjacent the element.

In an alternative embodiment, the seal wall or element is annular or ring-shaped, with the coiled arcuate sheet member extending outwardly and with the extension member affixed to a housing, where the seal element abuts a shaft member, such that the coiled sheet member allows the element to roll or rotate as the shaft is advanced or retracted relative to the housing, and further allows the element to be disposed away from the location of the central axis in the passive state.

### BRIEF DESCRIPTION OF THE SEVERAL VIEWS OF THE DRAWING

The novel features which are believed to be characteristic of this invention are set forth with particularity in the appended claims. The invention itself, however, both as to its organization and method of operation, together with further objects and advantages thereof, may best be understood by reference to the following description taken in connection with the accompanying drawings, in which:

FIG. 1 shows an embodiment of the seal, where the wall or element is tubular;

FIG. 2 shows the seal attached to a windowsill with the bottom rail of a window sash just encountering the seal;

FIG. 3 shows the seal unrolled and compressed;

FIG. 4 shows the rolling seal attached to a vertical part of a window frame with a vertical part of a window sash rolling and compressing the seal;

FIG. 5 is a cross-sectional view of an alternative embodiment of the invention, where the resilient, compressible wall or element is solid rather than tubular;

FIG. 6 is an end view of another alternative embodiment of the invention, where the seal wall or element is configured as an O-ring;

FIG. 7 is a cross-sectional view taken along line VII-VII of FIG. 6, showing the seal in relation to a moving shaft;

FIG. 8 is a cross-sectional view of an alternative embodiment of the invention, where the extension member is wedge-shaped;

FIG. 9 is a cross-sectional view of an alternative embodiment of the invention; where the extension member is stepped;

FIG. 10 is a cross-sectional view of an alternative embodiment of the invention, where the arcuate sheet member extends approximately 180° from the attachment edge;

FIG. 11 is a cross-sectional view of an alternative embodiment of the invention, where the seal wall or element is generally elliptical in shape;

FIG. 12 is a cross-sectional view of an alternative embodiment of the invention, where the seal wall or element is a polygon in the form of a square;

FIG. 13 is a cross-sectional view of an alternative embodiment of the invention, where the seal wall or element is a polygon in the form of a rectangle;

FIG. 14 is a cross-sectional view of an alternative embodiment of the invention, where the seal wall or element is a polygon in the form of a hexagon; and

FIG. 15 is a cross-sectional view of an alternative embodiment of the invention, where the seal wall or element is a polygon in the form of a triangle.

### DETAILED DESCRIPTION OF THE INVENTION

Many illustrated embodiments are disclosed herein and reference characters generally referring to similar components will have the same base character, for example, 10, 10A, 10B, etc.

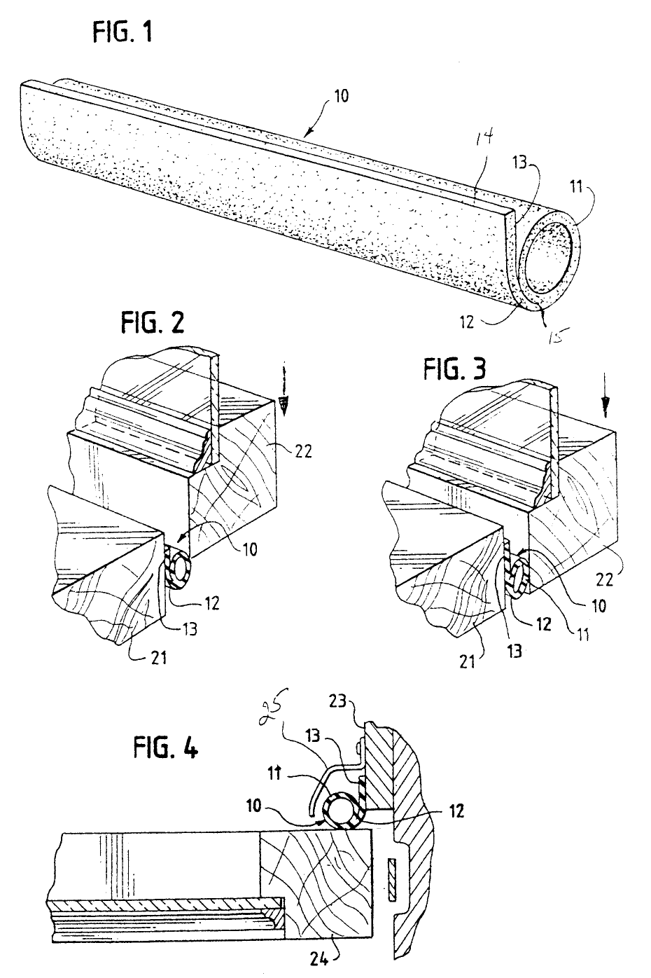

The new rolling seal 10 is shown in FIG. 1. The seal 10 has a seal wall or element 11, which is generally in the form of a right circular cylinder, which may be tubular as shown in FIGS. 1 through 4 or solid as shown in FIG. 5. An arcuate sheet member 12 having an attachment edge 15 is joined longitudinally to the element 11, either continuously or intermittently, and is curled along an arc of the wall 11 in spatial relation. An extension member 13 is joined to arcuate sheet member 12, which is preferably generally planar but may also have other varying configurations, extends outward from the arcuate sheet member and terminates in a free edge 14. The extension member 13 is spaced away from edge 15 and such member 13 is adapted to be attached to a first surface by the use of adhesives, mechanical fasteners or other suitable means to secure the seal 10 in proper position during use.

The rolling seal 10 is formed of a resilient, compressible material, preferably comprising a rubber, polymer material or polymer foam, such as, for example, silicone, vinyl or the like. Preferably, the seal 10 is formed as an extrusion such that the seal 10 is a unitary piece, although it would be possible to construct the seal 10 from separate components.

In the passive state, where no pressure is directed against the wall or element 11, the arcuate sheet 12 and the extension member 13 reside in a spaced relation to the wall 11, such that the only contact between the wall 11 and the coiled arcuate sheet 12 occurs along the attachment edge 15. With the extension member 13 affixed to a first surface, the coiled sheet 12 and wall 11 will be disposed spacedly away from such first surface.

In FIGS. 2 and 3, the extension member 13 only is shown attached to a first surface, which in this case is a windowsill 21, and the effects of pressure being applied against the wall 11 in a first direction are shown. Here a second surface, which in this case is a bottom rail of a window sash 22, is just encountering the seal wall or element 11, with the sash 22 shown being moving in a downward direction toward the seal 10. In FIG. 3 the sash 22 is disposed opposite the sill 21, i.e., the window is shown in the closed state, and the contact between the sash 22 and the element 11 has unrolled or flattened the curled sheet member 12 in the direction away from the attached extension member 13, and has simultaneously compressed the element 11 in the interface between the sill 21 and the sash 22, thereby sealing the interface between the opposed surfaces. Because of the curl of arcuate sheet member 12, the element 11 is able to roll or rotate to reduce the abrasive friction effects from contact with the sash 22.

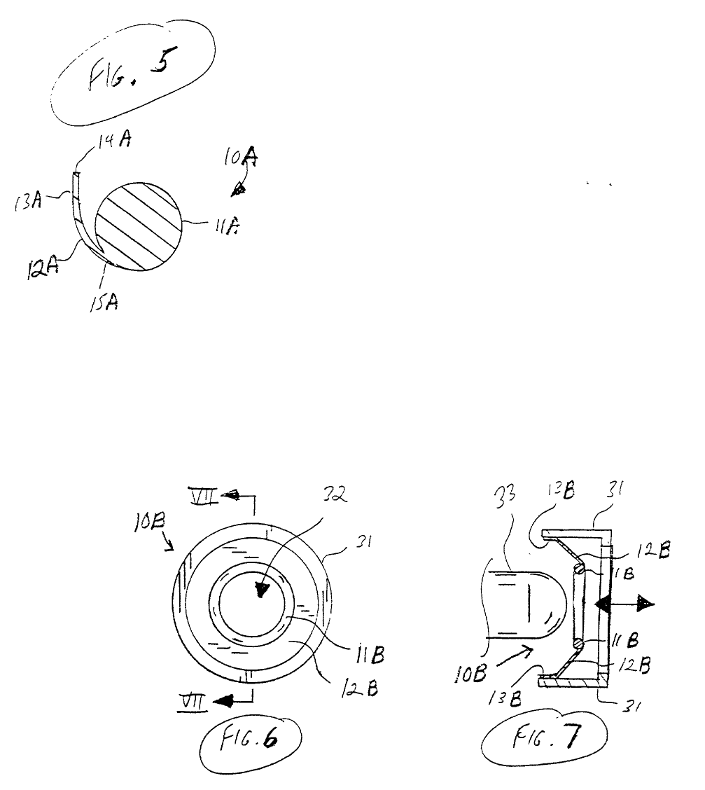

In FIG. 4, the extension member 13 is shown attached to a first surface, which in this case is a vertical portion of a window frame 23 having a seal protective cover 25. Here a second surface, which in this case is the upper portion of a window sash 24, contacts the seal 10 as the sash 24 is lowered to close the window. This contact with the sash 24 rolls the curled sheet member 12 toward the attached extension member 13 and compresses the element 11 to seal the interface between the frame 23 and the sash 24. As above, the curled arcuate sheet member 12 allows the wall 11 to roll or rotate to reduce the friction effects.

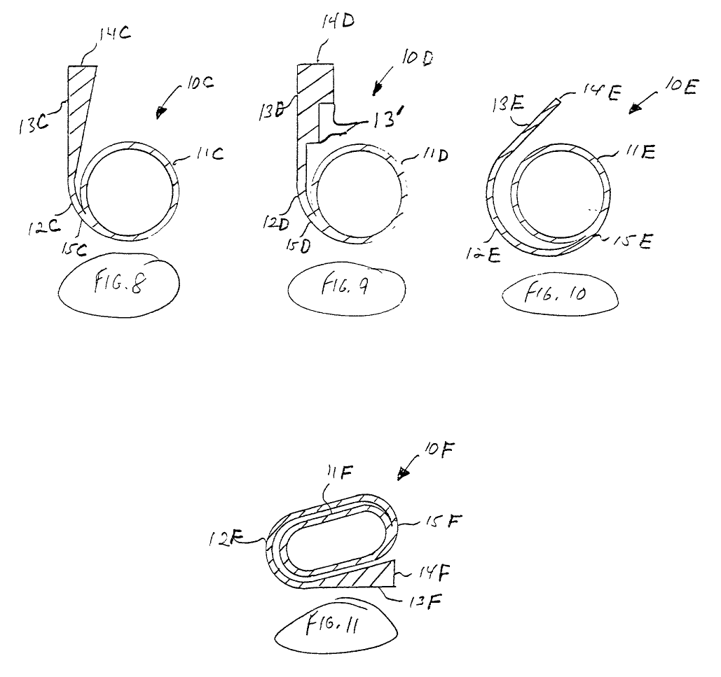

The amount of resistance to roll or rotation for element 11 is controlled by the material chosen to compose the curled sheet member 12, with a stiffer material providing less roll than a more pliant material, or by the thickness of the curled sheet member 12. A thick curled sheet member 12 will provide a more stable passive position for the seal 10, but will allow for less roll than a thinner curled sheet member 12. The resistance to roll may also be controlled by varying the configuration of the extension member 13C or 13D, such as shown respectively in FIGS. 8 and 9. In FIG. 8, the extension member 13C is formed in a wedge shape, such that the element 11C encounters a thicker portion of the extension member 13C as the element 11C is rolled against the curled sheet member 12C, thereby reducing roll and increasing compression effects on the element 11C. In FIG. 9, the extension member 13D is formed in a stepped configuration, such that as the element 11D is rolled the resistance to roll increases incrementally when one of the 13′ steps is encountered.

In FIGS. 2 and 3, the first surface 21 and the second surface 22 are shown to be generally parallel and both generally planar, and in FIG. 4, the surfaces 23 and 24 are shown to be generally parallel and generally perpendicular. Other configurations would be substantially equivalent. The surfaces need not be parallel and they need not be planar. For example, the sill can be angled away from the vertical plane of the sash and could be provided with a lip extending toward the sash in order to minimize the space between the sill and the sash when the window is closed.

In a preferred embodiment, the curled sheet member 12 is wound around wall 11 over an arc covering at least 45° from the attachment edge 15 on element 11. As shown in FIG. 10, the arc of the curled sheet member 12E may even comprise up to or more than 180° from the attachment edge 15E.

Other forms for the wall or element 11, the curled sheet member 12, and the extension member 13 would be substantially equivalent. For example, a curled sheet member 12 and an extension member 13 need only be provided at spaced intervals along the wall or element 11, the cylinder ends could be joined to form a ring seal as illustrated in FIGS. 6 and 7 (hereinafter more fully described), and the wall or element 11 could bound a cylinder which is not a circular cylinder, as illustrated in FIGS. 11-15 (hereinafter more fully described). Many variations are possible so long as the seal can be attached to a first surface, unrolled, and rolled, and compressed in the interface with a second surface by relative motion between the first surface and the second surface. An alternative embodiment is shown in FIG. 11, where the wall or element 11F is elliptical in configuration.

Although the seal 10 has been described herein in relation to window closures, it is to be understood that the seal 10 can be utilized in a multitude of situations where a compressible seal is desired between two relatively movable members or surfaces, such as for example, a doorway.

A further alternative embodiment of the seal 10B in the nature of an o-ring is shown in FIGS. 6 and 7. In this embodiment, the wall or element 11B is a circular or annular member forming a circular aperture 32, and the curled arcuate sheet member 12 B extends outwardly from the element 11B, preferably over the full 360° extent of the element 11B. The extension member 13B is attached to a first surface, here shown as a housing 31. A second surface, here shown as a shaft 33, passes through the aperture 32 and contacts the seal element 11B. In a manner similar to that set forth above, the curled sheet member 12B allows the element 11B to rotate or roll in response to movement of shaft 33 relative to housing 31, thereby reducing the abrasive friction effects. Furthermore, because the sheet member 12B is formed of a resilient material, the central axis of the aperture 32 can be disposed in any direction perpendicular to the axis, i.e., can be shifted off-center, without causing the element 11B to lose contact with the shaft 33.

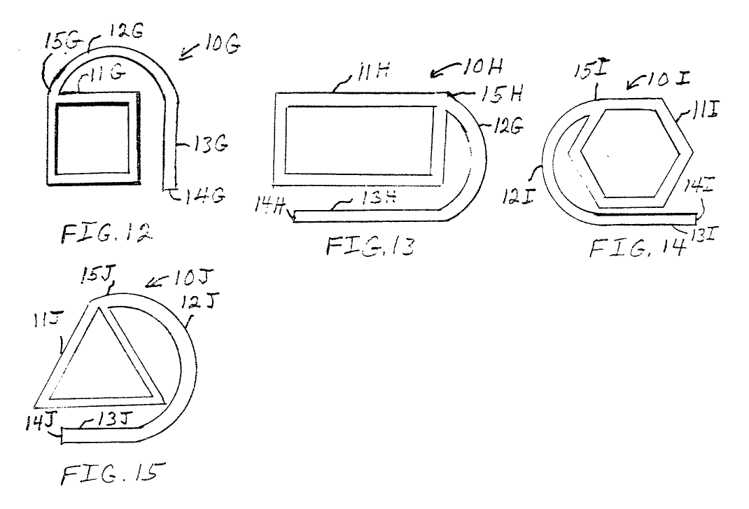

As illustrated in FIGS. 11-15, the wall or element 11F-J may be of any contour that will permit the rolling out or rolling up of the curled arcuate sheet member 12F-J. Also, a more compressed state of the seal 10F-J is achievable with less rolling motion than the cylindrical or round embodiments of the seal 10, and 10C-10E. Pointed corners of element 11G-J achieve greater pressure per square inch since there is less contact surface when a corner is being compressed than when a flat side or the respective seal is being compressed. The polygons, illustrated in FIGS. 12-15, are understood not to be limiting but other cross-sectional shapes, such as a pentagon, octagon, etc., are envisioned as well as trapezoids, parallelograms, etc. Also, the tubular form of wall or element 11F-11J may be solid, like 11A in FIG. 5, and all corners may be rounded rather than being sharp, as would be understood in the art.

Other equivalent forms for the wall or element 11, the curled sheet member 12, and the extension member 13 attaching the seal to a surface will be obvious hereafter to persons skilled in the art. Therefore, this invention is not limited to the particular examples shown and described here, but instead the true scope and definition of the invention is to be as set forth in the following claims.

1. A rolling seal useable with a closure having first and second surfaces movable relative to each other, the rolling seal comprising:
a contoured element having a predetermined shape, said element being resiliently compressible;
a curled resilient sheet member having opposite attachment edges with one of said attachment edges being connected to said element, said sheet member being curled about said element when said seal is in a passive condition; and
an extension member joined to another of said edges of said sheet member, said extension member being adapted to be joined to a first surface of a closure to position said sheet member closely spaced from a first surface of a closure when said seal is in said passive condition, said sheet member being straightened against a first surface when said element rolls to an active condition caused by movement of a second surface engaging said element.

2. The seal of claim 1, where said element is generally a right circular cylinder.

3. The seal of claim 1, where said extension member is generally planar.

4. The seal of claim 1, where said extension member is wedge-shaped.

5. The seal of claim 2, where said extension member is stepped.

6. The seal of claim 1, where said element is tubular.

7. The seal of claim 1, where said element is solid.

8. The seal of claim 1, where said sheet member is curled around said element over an arc at least 45 degrees from one said attachment edge.

9. The seal of claim 1, where said element is annular.

10. The seal of claim 1 where said element includes at least one corner.

11. The seal of claim 1 where said element in cross-section is a polygon.

12. The seal of claim 1 where said element in cross-section is generally elliptical.

13. In combination with a closure having first and second surfaces, a rolling seal comprising:
a resiliently compressible element generally in the form of a cylinder;
a curved sheet member having an attachment edge attached to said element, said sheet member being freely curled about said element and spaced from said first surface when said seal is in a passive condition;
an extension member attached to said sheet member, said extension member being attached to said first surface of said closure so that relative motion between said first and second surfaces in a first direction causes contact between said element and said second surface such that said element either is rolled away from said extension member and said sheet member is straightened relative to the passive condition or is rolled toward said extension member and said sheet member is curled further about said element into an active condition creating a seal between said first and second surfaces, and further so that relative motion between said first and second surfaces in a direction opposite to said first direction releases said element and said sheet member to resume said passive condition.

14. The seal of claim 11, where said extension member is generally planar.

15. In the combination of claim 11, where said extension member is wedge-shaped.

16. In the combination of claim 11, where said extension member is stepped.

17. In the combination of claim 11, where said sheet member is curled around said element over an arc at least 45 degrees from said attachment edge.

18. In the combination of claim 11, where said element is tubular.

19. In the combination of claim 11, where said element is solid.

20. In the combination of claim 11, where said element is a right circular cylinder.
